(19) United States
(12) Patent Application Publication
(10) Pub. No.: US 2024/0037446 A1
(43) Pub. Date: Feb. 1, 2024

(54) Method for Training a Classifier to Ascertain a Handheld Machine Tool Device State

(71) Applicant: Robert Bosch GmbH, Stuttgart (DE)

(72) Inventors: Andreas Vogt, Renningen (DE); Matthias Tauber, Duernau (DE); Frank Wolter, Renningen (DE)

(21) Appl. No.: 18/018,377

(22) PCT Filed: Jun. 23, 2021
(86) PCT No.: PCT/EP2021/067143

§ 371 Date: Jan. 27, 2023

(30) Foreign Application Priority Data
Aug. 4, 2020 (DE) 10 2020 209 809.3

(51) Int. Cl. G06N 20/00; B25F 5/00

(52) U.S. Cl. CPC G06N 20/00; B25F 5/00

(57) ABSTRACT

The disclosure relates to a method for training a classifier to determine a handheld machine tool device state, comprising the following steps:—providing a handheld machine tool; —providing at least one sensor; —operating the handheld machine tool continuously; —terminating the continuous operation, in particular in the event of damage occurring; —capturing sensor data during the continuous operation; —extracting features on the basis of the sensor data; —ascertaining at least two handheld machine tool device states on the basis of the extracted features.

### PRIOR ART

DE 103 21 869 A1 describes a hammer drill with a changeable tool holder.

### DISCLOSURE OF THE INVENTION

The invention relates to a method for training a classifier to determine a handheld machine tool device state, comprising the steps of:
providing a handheld machine tool;
providing at least one sensor;
operating the handheld machine tool continuously;
terminating the continuous operation, in particular in the event of damage occurring;
capturing sensor data during the continuous operation;
extracting features on the basis of the sensor data;
ascertaining at least two handheld machine tool device states on the basis of the extracted features.

A handheld machine tool is to be understood in this context as a device for machining workpieces by means of an electrically driven insertion tool. Typical handheld machine tools in this context are hand drills or stand drills, screwdrivers, percussion drills, hammer drills, impact hammers, angle grinders, planers, grinding devices or the like. The handheld machine tool preferably has a drive unit having an electric motor, which is connected to a tool holder either directly or via a transmission. The tool holder is designed in particular for releasable fastening of an insertion tool.

The handheld machine tool has a housing, which is designed as an outer housing at least partially, in particular completely. The housing can be made from one piece or multiple pieces. The housing is formed from a plastic at least partially, in particular completely. Furthermore, the housing of the handheld machine tool can have an inner housing, which is enclosed by the outer housing at least partially, preferably completely.

The electric motor of the drive unit can be designed as a DC motor or as an AC motor. Commutation of the electric motor can take place electronically or via carbon brushes. The electric motor is mounted rotatably about a motor axis in the housing of the handheld machine tool. The drive movement of the drive unit or of the electric motor can be transmitted via the transmission unit to the tool holder or to the insertion tool. The handheld machine tool can include a striking mechanism unit. The striking mechanism unit can be designed, for example, as a pneumatic striking mechanism or as a latching mechanism. The pneumatic striking mechanism can be designed, for example, as an eccentric striking mechanism or as a wobble mechanism. In particular, the striking mechanism unit has a guide tube in which a striker and/or a piston are accommodated in a linearly movable manner. The piston is preferably designed to be driven in a linearly oscillating manner via the eccentric striking mechanism or the wobble mechanism. The transmission unit is, in particular, designed such that an insertion tool connected to the tool holder can be driven such as to rotate about and/or linearly oscillate or hammer along a working axis.

The handheld machine tool preferably comprises electronics, which are designed to control or regulate the handheld machine tool, in particular the drive unit of the handheld machine tool. The electronics preferably have a printed circuit board (PCB) on which electronic components, such as a computing unit and storage unit, are arranged. The electronics furthermore have, in particular, at least one sensor. The at least one sensor can be arranged on the PCB or at another location within or outside the housing of the handheld machine tool. Alternatively or additionally, it is conceivable that at least one further sensor is provided, which is assigned to an external device, such as a smartphone. The electronics can have a communication unit by means of which the electronics can exchange information with another handheld machine tool, a handheld machine tool accessory, an external device, an external sensor, etc. The external device can be designed, for example, as a smartphone or as a server. The communication unit can be designed, for example, as a USB interface, i.e., wired, or as a Bluetooth or WLAN interface, i.e., wirelessly.

In the context of this application, a handheld machine tool device state is to be understood, in particular, as a device state which describes the functionality of the handheld machine tool. Alternatively or additionally, a handheld machine tool device state can also be understood to mean a change of a single function, in particular a change of a secondary function, such as an increase in operating noise. In particular, a handheld machine tool device state is not to be understood as an operating state, such as “on” or “off” or in which mode the handheld machine tool is operated, for example the speed, load state/idling speed, with the additional function switched on, such as a suction or a striking mechanism, etc.

In the context of this application, continuous operation is to be understood to mean, in particular, that the handheld machine tool is operated in the idle state for a long period of time, for example for one or more hours or one working day or continuously over several days. Alternatively, it would also be conceivable for the handheld machine tool to be operated in a load state for a longer period of time. In contrast to the idle state, the handheld machine tool is operated under load in the load state in order to, for example, drill a borehole, machine a workpiece, place a fastening element, etc. Advantageously, there are fewer disturbances in continuous operation than in normal operation, and therefore faster training and better or unambiguous assignment of the features is possible. Alternatively or additionally, it is conceivable for sensor data to be detected in real working mode, i.e., in a load state or when switching between a load state and an idle state, and to be provided for training the classifier.

In the context of this application, a case of damage is to be understood, in particular, as a damage, a defect or a functional restriction of the handheld machine tool, which prevents or limits the use of the handheld machine tool. The restriction can be, for example, the failure of a function, e.g., of an impact function, or a reduction in power. Furthermore, a functional restriction is to be understood, in particular, also as a deterioration of a secondary function, such as an increase in noise or a reduction in efficiency due to increased current consumption.

In this context, a feature is to be understood to mean, in particular, a physical parameter such as a temperature, an acceleration, a movement, a weight, a current, a torque, a pressure, a usage time, a speed of the electric motor, etc. The extracted features can be, for example, an absolute value, an averaged value, a measured or estimated value, a frequency, an amplitude, a slope, or further signal features derived from the sensor signals. It is also conceivable that the features or the signal features are ascertained by machine learning methods or artificial intelligence methods.

The method for training a classifier is a partially or fully computer-implemented method, with which classification is carried out by automatic processes, in particular using machine learning methods. The features can be selected by algorithm or by a user or, in this case, by a software developer or hardware developer. Ascertaining the handheld machine tool device states based on the extracted features can take place through monitored learning, wherein the algorithm is informed whether a feature is assigned to a device state or not (for example by a user). Alternatively or additionally, ascertaining the handheld machine tool device states based on the extracted features can also take place through unmonitored learning where the algorithm automatically or independently assigns features handheld machine tool device states. The handheld machine tool device states correspond to different classes. Assignment takes place with common classification algorithms, such as KNN (k-nearest-neighbor), SVM (supported vector machines), decision trees, neural networks, or the like.

Furthermore, it is proposed that the handheld machine tool is designed as a handheld test machine tool, which has more sensors than an in particular planned commercial device. Advantageously, more features can be extracted with such a handheld test machine tool than with a commercial device, which usually has only sensors necessary for the operation of the handheld machine tool. Advantageously, a larger number of sensors are thus used in the development phase in order to ascertain the relevant signals or information.

The sensors can be internal sensors arranged in the housing of the handheld machine tool or external sensors arranged at or outside the housing of the handheld machine tool. The sensor can be designed, for example, as a motion sensor, in particular an acceleration sensor or a gyro sensor, as a temperature sensor such as an NTC or a PTC, as a current sensor, as a speed sensor, as a structure-borne sound sensor, as a microphone, as a Hall sensor, as a pressure sensor, as a force sensor, in particular a capacitive or resistive force sensor, as an optical sensor, for example in the form of a camera, etc. The acceleration sensor can be designed, in particular, as a MEMS acceleration sensor, preferably with a bandwidth of at least 2 kHz, preferably at least kHz. The microphone is designed, in particular, as a MEMS microphone.

It is further proposed that the handheld test machine tool has at least three different sensors, preferably at least four different sensors, preferably at least five different sensors. In particular, the handheld test machine tool has at least one of the different sensors more than once, preferably more than twice, at the same or different positions. Preferably, the number of extractable features can be thus increased.

In addition, it is proposed that at least one of the sensors is arranged in a region where damage is to be expected or in which increased wear occurs or in which overloading or overheating is to be expected. Advantageously, this can increase the probability that the optimum features for ascertaining the handheld machine tool device states are extracted.

Furthermore, it is proposed that extraction of the features is done by means of principal component analysis (PCA), as a result of which the number of features is reduced or a weighting takes place. In particular, the relevant features can be extracted by means of PCA. PCA is a mathematical method performed as a computer-implemented method step. PCA can take place by means of the handheld machine tool or locally in the handheld machine tool or by means of an external device or in an external computing unit.

It is further proposed that at least three handheld machine tool device states are ascertained, a new handheld machine tool device state, a used handheld machine tool device state and a defective handheld machine tool device state. Preferably, at least four handheld machine tool device states are ascertained, wherein an additional critical handheld machine tool device state is ascertained.

It is moreover proposed that in an additional step a type of damage is ascertained, wherein the type of damage is assigned to a handheld machine tool device sub-state. Advantageously, the type of damage can be thus ascertained. Ascertaining of the damage is preferably carried out by a user. For this purpose, partial disassembly of the handheld machine tool may be necessary. The handheld machine tool device sub-state corresponds in particular to a sub-class.

Furthermore, it is proposed that a quality of the classifier is evaluated by means of commercial devices and/or used commercial devices. Advantageously, the quality of the classifier can be thus checked.

The invention further relates to a method for determining a handheld machine tool device state, comprising the steps of:
providing a used or defective handheld machine tool;
capturing sensor data, in particular by means of an external sensor;
extracting features on the basis of the sensor data;
ascertaining a handheld machine tool device state, in particular a handheld machine tool sub-state, on the basis of the extracted features.

Advantageously, a precise determination of the state of the handheld machine tool can be thus realized. The external sensor can be designed, for example, as a microphone, in particular a microphone of a smartphone.

In addition, it is proposed that the handheld machine tool is repaired and sensor data are captured by the repaired handheld machine tool, which are in turn used for training the classifier. Advantageously, further handheld machine tool sub-states can be thus ascertained.

The invention further relates to a handheld machine tool monitoring device with a classifier trained as described above. The handheld machine tool monitoring device is designed to ascertain the handheld machine tool device state.

The invention further relates to a handheld machine tool or a handheld machine tool accessory with a handheld machine tool monitoring device, wherein a number of sensors, a position of the respective sensors and/or a type of the respective sensors in the handheld machine tool was determined with the previously described method.

### DRAWINGS

Further advantages result from the following description of the drawings. The drawings, the description, and the claims contain numerous features in combination. A person skilled in the art will expediently also consider the features individually and combine them to form meaningful further combinations.

The following are shown:

FIG. 1 a section through a handheld machine tool, which is designed as a test device;

FIG. 2 a flowchart of a method for training a classifier;

FIG. 3 an evaluation of a PCA analysis;

FIG. 4 an assignment of handheld machine tool device states based on the principal components of the PCA;

FIG. 5 a checking of the quality of the classifier;

FIG. 6 a section through a handheld machine tool, which is designed as a commercial device;

FIG. 7 a section through an alternative handheld machine tool which is designed as a commercial device.

### DESCRIPTION OF THE EXEMPLARY EMBODIMENTS

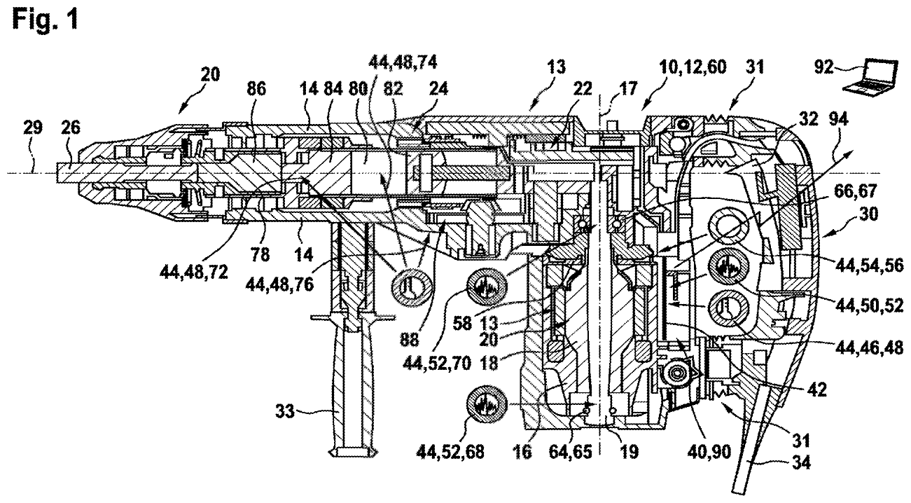

FIG. 1 shows a longitudinal section of a handheld machine tool 10 in the form of a hammer drill 12. The handheld machine tool 10 has a housing 13, which comprises an outer housing and an inner housing. A drive unit 20 having an electric motor 18 is arranged in the housing 13 of the handheld machine tool 10 and transmits a drive movement to a transmission unit 22, which has a striking mechanism unit 24. The striking mechanism unit 24 is designed, for example, as a pneumatic striking mechanism.

The inner housing has a motor housing 16 and a transmission housing 23, which are enclosed by the outer housing. The striking mechanism unit 24, in particular the transmission unit 22, is accommodated substantially completely in the transmission housing 23. The transmission housing 23 at least partially spans a grease cup, in which a lubricant for lubricating the transmission unit 22 is arranged. The motor housing 16 is designed in particular for receiving and/or holding the electric motor 18. The transmission housing 23 consists, for example, of a different material than the rest of the outer housing. The transmission housing 23 consists, for example, of a metallic material, while the motor housing 16 and the outer housing consist of a plastic. However, it is also conceivable for the transmission housing 23 to consist of a plastic. In particular, the transmission housing 23 and/or the motor housing has a higher strength and/or temperature resistance than the outer housing.

The drive movement of the drive unit 20 is transmitted via the transmission unit 22 to a tool holder 20, in which an insertion tool 26 is releasably fastened. The insertion tool 26 is designed, for example, as a rock drill for drilling holes in concrete. The insertion tool 26 is designed such as to rotate about and/or linearly oscillate or hammer along a working axis 29. In addition, the insertion tool 26 can be driven clockwise or counterclockwise. The working axis 29 extends, for example, in a crossing manner, in particular substantially perpendicular, to a motor axis 17 of the drive unit 20.

The handheld machine tool 10 has a handle 30. The handle extends substantially perpendicular to the working axis 29. The handle 30 is arranged on a side of the housing 13 facing away from the tool holder 20. The handle 30 has an operating switch 32, with which the handheld machine tool 10 can be manually controlled or switched on and off. The operating switch 32 is designed as a signal switch, for example. The handle 30 is designed, for example, as a vibration-decoupled handle 30. The handle 30 is, in particular, connected to the housing 13 of the handheld machine tool 10 via a damping unit 31. The handle 30 is connected to the housing 13 such as to be movable relative thereto. The handheld machine tool 10 furthermore has an additional handle 33, which is detachably connected to the housing 13.

The handheld machine tool 10 is designed, for example, as a handheld power machine tool, which can be connected via a power cable 34 to a power supply, such as a power grid. Alternatively, it would also be conceivable for the handheld machine tool 10 to be designed as a cordless handheld machine tool having a battery interface, via which a battery pack can be electrically and mechanically connected to the handheld machine tool in a manner such as to be releasable without tools.

The handheld machine tool 10 has electronics 40. The electronics 40 are designed for controlling or regulating the handheld machine tool 10. The electronics 40 comprise a PCB 42 on which a computing unit for performing computing operations and a memory unit for storing data are arranged. The PCB 42 extends, in particular, directly adjacent to the electric motor 18 and along the motor axis 17.

The handheld machine tool 10 has a plurality of sensors 44. A first sensor 46, which is designed as a temperature sensor 48, and a second sensor 50, which is designed as an acceleration sensor 52, are arranged on the PCB 42. The temperature sensor 48 is designed to capture a temperature variable, which is provided to the electronics 40. A temperature can be ascertained by the electronics 40 based on the temperature variable, wherein the handheld machine tool 10 can be controlled based on the temperature. For example, an emergency shutdown or a reduced power operation can be initiated by the electronics 40 if the temperature exceeds a threshold value. The acceleration sensor 52 is designed to capture an acceleration variable, which is provided to the electronics 40. The acceleration variable can be used, for example, to detect whether the handheld machine tool 10 is in an idle mode or a load operation mode, wherein the handheld machine tool 10 is driven at a higher power and/or a higher engine speed in the load operation mode. In addition, the acceleration variable can be used to ascertain reinforcements, in which case the handheld machine tool 10 is actively decelerated. The handheld machine tool 10 further comprises a third sensor 54, which is designed as a Hall sensor 56. The Hall sensor 56 is designed to capture a speed variable of the electric motor 18, which is provided to the electronics 40 that control or regulate the electric motor based on the speed variable. The third sensor 54 is arranged on a PCB 58 of the drive unit 20. The PCB 58 of the drive unit 20 extends partially around a motor shaft 19 of the electric motor 18.

Employment of the first sensor 46, the second sensor 50 and the third sensor 54 are known to the person skilled in the art and are used as such in commercially available hammer drills.

The handheld machine tool 10 shown in FIG. 1 is designed as a handheld test machine tool 60, which has additional sensors 44 for capturing sensor data. Two additional sensors 44, which are arranged in the region of a first bearing point 64 and a second bearing point 66 of the motor shaft 19, are arranged in the region of the drive unit 20. The first bearing point 64 is arranged on a side of the drive unit 20 facing away from the transmission unit 22 and is designed as a ball bearing 65. The first bearing point 64 is arranged, in particular, in the motor housing 16. A fourth sensor 68 in the form of an acceleration sensor 52 is arranged in the region of the first bearing point 64. The fourth sensor 68 can rest directly against the ball bearing 65 or be fastened in the near region, for example on the motor housing 16. The second bearing point 66 is arranged on a side of the drive unit 20 facing the transmission unit 22 and is designed as a ball bearing 67. The second bearing point 66 is arranged, in particular, in the transmission housing 23. The fifth sensor 70 is also designed as an acceleration sensor 52 and is arranged in the region of the second bearing point 66. During operation of the handheld machine tool 10, an increased wear occurs in the region of the first and second bearing points 64, 66, which wear can be detected and ascertained via sensor data of the fourth and fifth sensors 68, 70.

The handheld machine tool 10 has additional sensors 44 in the region of the transmission unit 22. A sixth sensor 72, a seventh sensor 74 and an eighth sensor 76 are arranged in the region of the transmission unit 22, in particular in the region of the striking mechanism unit 24, which are designed as temperature sensors 48. The striking mechanism unit 24 heats up very strongly during operation; in the used or defective state, the temperatures can increasingly rise in individual regions, as a result of which the state can be determined based on these temperatures.

The sixth sensor 72 is arranged, for example, outside a hammer tube 78, in which an air spring is formed between a drive piston 82 and a striker 84 in a compression chamber 80 during operation of the striking mechanism unit 24. The striker 84 is driven by the drive piston 82 or the air spring and acts on a firing pin 86, wherein the drive piston 82, the striker 84 and the firing pin 86 are arranged in a linearly movable manner in the hammer tube 78. The sixth sensor 72 is arranged in particular in a region, in which the striker 84 impinges on the firing pin 86. The seventh sensor 74 is arranged in the region of the compression chamber 80. The seventh sensor 74 can be arranged inside or outside the hammer tube 78. The eighth sensor 76 is arranged in a region adjacent to an override coupling 88. The eighth sensor 76 is arranged, for example, between the transmission housing 23 and the outer housing.

For example, all sensors 44 are connected to the electronics 40, so that all captured sensor data are provided to the electronics 40. The electronics 40 in turn have a communication unit 90, via which the handheld machine tool 10 can transmit 94 information, in particular the sensor data, to an external device 92. Communication takes place, for example, via Bluetooth, but other communication options would also be conceivable, such as WLAN or a wired exchange via USB. The external device 92 is designed as a laptop, for example. However, it would also be conceivable for the external device 92 to be designed as a smartphone or as a server or a computing network in the form of a cloud. It is essential for the external device 92 to have sufficient computing power for training a classifier.

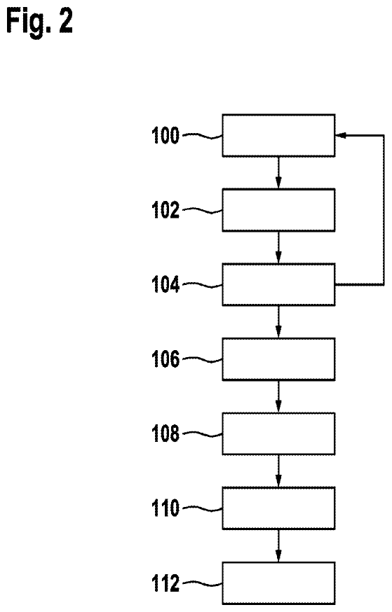

The method for training a classifier to determine a handheld machine tool device state is preferably carried out on an external device 92, which can be connected directly or indirectly, i.e., via at least one further external device 92, to the handheld machine tool 10. FIG. 2 describes the method for training the classifier, for example, with reference to a flowchart.

In a first step 100, a continuous operation is carried out with the handheld machine tool 10. The continuous duration lasts several hours, for example eight hours, during which the handheld machine tool 10 is operated in idle mode, and sensor data are captured by means of the sensors 44 and stored in the memory unit of the electronics 40 in a step 102. It would also be conceivable to carry out the continuous operation in the load state, for example during drilling or chiseling, but interference is more likely to occur in this case. In a step 104, the captured sensor data are transmitted to an external device 92, on which the method for classification is carried out. Steps 100, 102, 104 are preferably repeated until, in a step 106, the handheld machine tool 10 is defective or no longer operable and the continuous operation is terminated.

After completion of the continuous operation, in a step 108, a large number of features are first extracted from the recorded sensor data on the external device 92. The features are specific sensor data of the sensors 44, in particular, and, for example, mean values, standard deviations, skewness, kurtosis, maxima of frequency spectra, energies of the signals in certain frequency bands, amplitudes, spectra of signal envelopes, etc.

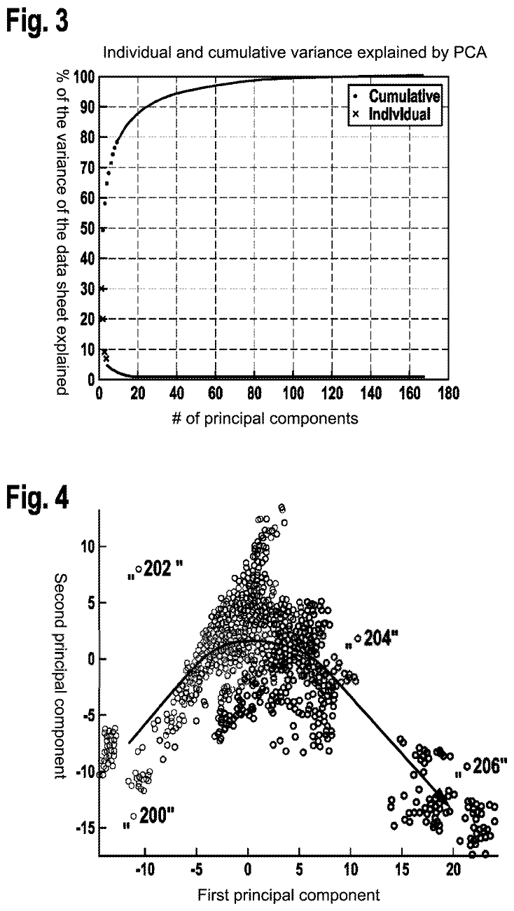

In a step 110, which features describe the change of the handheld machine tool device state with sufficient accuracy is determined with the aid of PCA. The selection of the relevant features thus takes place automatically. FIG. 3 shows an exemplary PCA evaluation. In this example, the calculation based on PCA shows that in order to describe the handheld machine tool state changes, only 10 features are sufficient to describe 80% of the state changes. This allows for a targeted selection of the features and thus for a reduction in the signals or signal properties to be evaluated, which can also involve a reduction in sensors.

In the subsequent step 112, those classification algorithms are trained, which recognize whether individual features in a feature space that corresponds to a handheld machine tool device state are close to each other, i.e., similar. Features that are close to each other are used to ascertain the handheld machine tool device state, since it is known in what state the handheld machine tool 10 was during continuous operation.

In FIG. 4, for example, the most relevant features according to PCA are plotted against one another and assigned to four handheld machine tool device states. The four handheld machine tool device states are a new handheld machine tool device state 200, a used handheld machine tool device state 202, a critical handheld machine tool device state 204 and a defective handheld machine tool device state 206. It can be clearly seen that the new handheld machine tool device state 200 and the defective handheld machine tool device state 206 can be clearly distinguished from one another already in the illustration having only 2 features. By adding further features, the classification algorithms can also differ precisely between the used handheld machine tool device state 202 and the defective handheld machine tool device state 206. Moreover, by repeating the data acquisition with other handheld machine tools 10 that have other defects, it is also possible to ascertain handheld machine tool device sub-states that correspond to specific damage such as defects at the first or second bearing point 64, 66 or to a defect in the region of the override coupling 88. Accordingly, an assignment of certain damage, defects or machine elements is possible based on the position of the accumulations in the feature space. Different defects, such as gearwheel wear, tooth breakage, bearing damage or the like, result in the handheld machine tool device state being in a different region in the feature space. This means that the type of damage can also be determined based on the position of the handheld machine tool device state in the feature space, and thus that the type of damage can be ascertained. Thus, the defective or critical component can be identified and replaced. The knowledge regarding the defective component can also be used to order the defective component before the device arrives at the service department, which can speed up the repair process.

In addition, it is also conceivable that additional data or features are used for the new handheld machine tool device state 200, which data or features are captured, for example, during production of the handheld machine tool, such as, for example, logged drawing features such as roughness or dimensions of components. It is then possible to compare these values with those that are present in the used, critical, and defective handheld machine tool device states. If these values can be accessed or captured also during operation of the devices, they can serve as further features.

The training phase of machine learning can be completed with step 112. However, it is also conceivable that further handheld machine tools 10 with possibly different sensors 44 are used to capture more sensor data. It is also conceivable to use the data obtained during application of the device data not only for assessing the state, but also for continuously improving the classification algorithms.

During the application phase, the handheld machine tools as series devices are preferably equipped with sensors 44, from the sensor data of which the most relevant features can be captured in order to ascertain the handheld machine tool device states. Thus, the sensors of the series devices are advantageously selected and positioned based on the findings of the classification method. The series devices have, in particular, additional sensors, wherein the handheld machine tool or series device is not controlled or regulated by means of the additional sensors, but only sensor data for maintenance or for ascertaining the handheld machine tool device state is detected.

The trained classification algorithm can be used on the external device 92, such as an external server or a cloud, or on the handheld machine tool or the series device itself. Transmission to an external device 92 such as a cloud is advantageous especially in the application phase in order to monitor the states of a plurality of devices in databases and, if necessary, initiate measures such as maintenance or repair. In addition, the classification algorithm can also be improved further based on the recorded data of the plurality of devices.

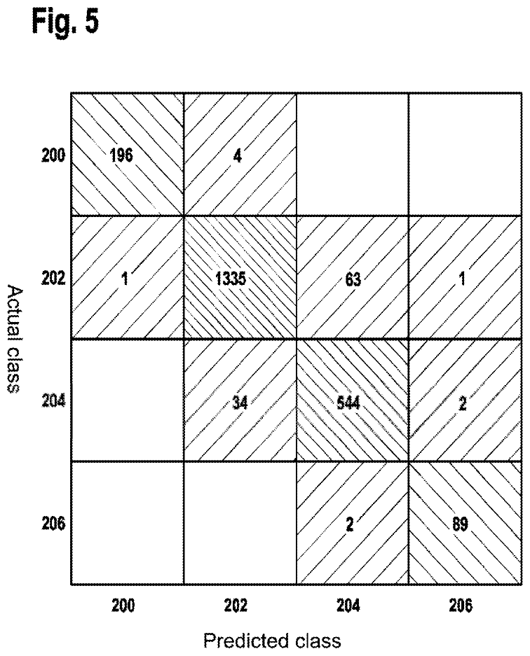

FIG. 5 shows an evaluation of the quality of the classification algorithms for checking the quality of the algorithm. The actual handheld machine tool device states are plotted on the vertical axis, and the handheld machine tool device states assigned by the classification algorithm are plotted in the horizontal axis. For example, 196 out of 200 new handheld machine tools were correctly identified by the classification algorithm. The classification algorithm identified only 2 out of 91 defective handheld machine tools as being not defective but critical instead.

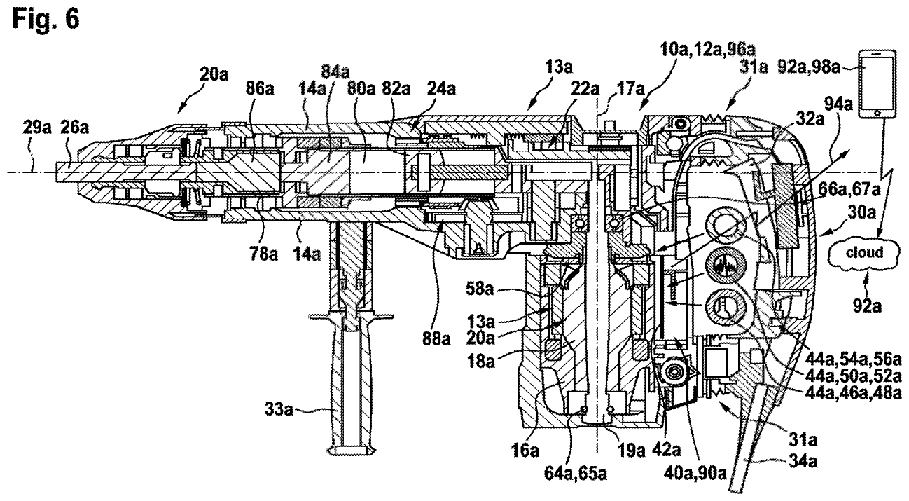

FIG. 6 shows a section through a handheld machine tool 10a, which substantially has the structure of the handheld machine tool 10 of FIG. 1. The handheld machine tool 10a is designed as a commercial device 96a intended for sale and for use by the user. The handheld machine tool 10a has, in particular, a reduced number of sensors 44a. All the sensors 44a are required for the operation of the handheld machine tool 10a and its functions.

Where a diagnosis of the handheld machine tool 10a is required, such diagnosis can be performed within handheld machine tool 10a, for example, based on provided sensor data of the sensors 44a. Alternatively, it is also conceivable for an external sensor 98a of an external device 92a to capture sensor data. The external sensor 98a is designed as a microphone of a smartphone, for example. The captured sensor data can then be applied using the trained classification algorithm to ascertain the handheld machine tool device state. The handheld machine tool device state can be ascertained on the external device 92a, which is designed as a smartphone, or on a further external device 92a, which is designed, for example, as a cloud.

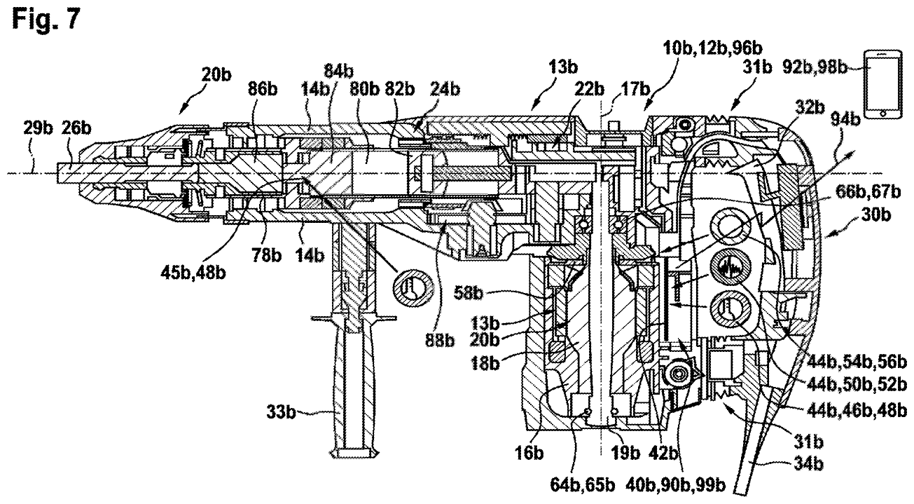

FIG. 7 shows a section through a further handheld machine tool 10b, which is designed as an alternative commercial device 96b. Unlike the handheld machine tool 10a, the handheld machine tool 10b has an additional sensor 45b in the region of the striking mechanism unit 24b. The sensor 45b is designed as a temperature sensor 48b. The position or arrangement of the additional sensor 45b was ascertained using the trained classification algorithm. The sensor 45b is assigned to a handheld machine tool monitoring device 99b, wherein the sensor data are provided to said device. The handheld machine tool monitoring device 99b is assigned to the electronics 40b of the handheld machine tool 10b and comprises the trained classification algorithms. The handheld machine tool monitoring device 99b ascertains the handheld machine tool device state based on the captured sensor data, in particular from the sensors 44b and the additional sensor 45b. The handheld machine tool device state can be provided to the user via an HMI (not shown in detail) or a screen. Alternatively or additionally, the handheld machine tool state can be provided to the external device 92b.

1. A method for training a classifier to determine a handheld machine tool device state, comprising:
providing a handheld machine tool;
providing at least one sensor;
operating the handheld machine tool continuously during an operating state;
terminating the continuous operation in response to damage occurring;
capturing sensor data associated with the operating state;
extracting features on the basis of the sensor data; and
ascertaining at least two handheld machine tool device states on the basis of the extracted features.

2. The method for training a classifier according to claim 1, wherein the handheld machine tool is designed as a handheld test machine tool, which has more sensors than a planned commercial device.

3. The method for training a classifier according to claim 2, wherein the handheld test machine tool has at least three different sensors.

4. The method for training a classifier according to claim 3, wherein at least one of the at least three different sensors is arranged in one of a region where damage is expected, a region in which increased wear is expected to occur, and a region in which overloading or overheating is expected.

5. The method for training a classifier according to claim 1, wherein the features are extracted by means of a principal component analysis.

6. The method for training a classifier according to claim 1, wherein at least three handheld machine tool device states are ascertained, the at least three handheld machine tool device states including a new handheld machine tool device state, a used handheld machine tool device state and a defective handheld machine tool device state.

7. The method for training a classifier according to claim 1, further comprising ascertaining a type of damage, wherein the type of damage is assigned to a handheld machine tool device sub-state.

8. The method for training a classifier according to claim 1, wherein a quality of the classifier is evaluated using at least one of a new commercial device and a used commercial device.

9. A method for determining a handheld machine tool device state, comprising:
providing a used or defective handheld machine tool;
capturing sensor data using an external sensor;
extracting features on the basis of the sensor data; and
ascertaining a handheld machine tool device state on the basis of the extracted features.

10. A handheld machine tool monitoring device with a classifier trained with the method according to claim 1.

11. A handheld machine tool or handheld machine tool accessory having a handheld machine tool monitoring device, wherein a number of sensors, a position of the respective sensors and/or a type of the respective sensors was determined with the method according to claim 1.
